(19) United States
(12) Patent Application Publication
(10) Pub. No.: US 2007/0133412 A1
(43) Pub. Date: Jun. 14, 2007

(54) Method of transferring data

(75) Inventors: Andreas Hutter, Munchen (DE); Klaus Illgner-Fehns, Munchen (DE); Christian Kissling, Piding (DE); Uwe Maurer, Grobenzell (DE); Daniel Simon, Munchen (DE); Marcel Wagner, Munchen (DE)

Correspondence Address: LERNER GREENBERG STEMER LLP, P O BOX 2480, HOLLYWOOD, FL, 33022-2480, US

(73) Assignee: Siemens Akiengesellschaft

(21) Appl. No.: 10/577,824

(22) PCT Filed: Oct. 29, 2004
(86) PCT No.: PCT/EP04/52732

§ 371 Date: May 22, 2006

(30) Foreign Application Priority Data
Oct. 31, 2003 (DE) 10350894.5

(51) Int. Cl. H04L 12/26; H04L 12/56

(52) U.S. Cl. 370/235; 370/395.21

(57) ABSTRACT

A method for transferring data between a first computer and a second computer includes detecting and recording occurrences, which reduce quality and which lead to a deterioration in the quality of the transferred data.

The invention relates to a method for transferring data between a first computer and a second computer as well as a corresponding data network and a corresponding computer program product.

Both the Internet and wireless access networks such as UMTS and WLAN are nowadays used to transmit a multiplicity of data. In particular these networks are being increasingly used for transmitting multimedia data, e.g. in the form of video streaming. Quality problems frequently arise here, resulting from the fact that multimedia streams are transported from a server to a client via different networks, which means that it is virtually impossible to guarantee continuously high and consistent data transfer quality. Thus a customer supplied with a multimedia stream by a provider (e.g. for video on demand or Internet radio) does not always get an optimum presentation of the multimedia content. If the provider is charging the customer for providing the multimedia content, having to pay for poor quality is often unacceptable to the customer.

Nowadays multimedia content is charged to the customer in relation to the volume of data transferred. In technical terms this is implemented by setting up a streaming session using a so-called session management protocol when a multimedia stream is requested. The setup and release of a session is stored in log files and databases. A bill is generated for the customer by searching the log files or databases for corresponding session setup and release and extracting therefrom the quantity of data transferred. The disadvantage of this is that the customer always pays the full price for data transfer regardless of the quality of the multimedia stream.

The object to the invention is therefore to create a method for transferring data which allows improved customer billing for transfer capacities.

This object is achieved by the independent claims. Further developments of the invention are defined in the dependent claims.

In the method according to the invention, data is transferred between a first computer and a second computer, quality-reducing events resulting in impairment of the quality of the transferred data being detected during transfer. These quality-reducing events are logged.

The invention is therefore based on the knowledge that events which constitute a perceptible quality impairment for a user of the transferred data can be detected and constitute important information for a provider.

In a particularly preferred embodiment, the method according to the invention is used for transferring digitized video images (also known as video streaming), in which case the following quality-reducing events are detected:
freezing of video images;
artifacts in video images;
reduction in the sharpness of video images.

The inventors have recognized here that, with the transfer methods used nowadays, it is easily possible technically to determine the above-mentioned events which are very annoying for a user.

In a particularly preferred embodiment, the fees payable by a user for data transfer are calculated as a function of the logged quality-reducing events. This enables a provider to provide a billing model for a customer which is transparent and geared to data quality, the dependence of the payable costs on the quality of the data being just one example of a billing policy, however. For example, it might also be possible for poor quality to be linked to other factors such as rates or a special right to cancel for the user.

In a particularly preferred embodiment of the method according to the invention, the first computer is a server and the second computer a client. A server is taken to mean a computer which supplies data which is received by a client, e.g. a terminal such as a laptop or cell phone. At least some of the quality-reducing events are detected in the client and reported to the server by means of a feedback message. The quality-reducing events are thus detected in the media player or decoder in the client which constitutes no problem technically. In a preferred variant, quantification measures are transmitted in the feedback message whereby the particular quality-reducing event is categorized and/or specified. Particularly for video transmission, the quality-reducing event can be assigned to one of the three above-mentioned event categories.

In another embodiment, the RTP/RTCP protocol(RTP=Real Time Protocol; RTCP=Real Time Control Protocol, document [1]) sufficiently known from the prior art is used for data transfer and the feedback message is transmitted in the RTCP protocol. The feedback message preferably comprises one or more bits, specifically one byte.

In a further variant of the method according to the invention, the first computer is again a server and the second computer again a client, but with at least some of the quality-reducing events being detected in the server. This has the advantage that the detection of the events is decoupled from the client so that any misuse by manipulation at the client is impossible. Such misuse could be the transmission of bogus feedback messages suggesting to the server that a quality-reducing event has occurred even though this is not in fact the case. A user could thereby attempt to reduce the price for a data transfer.

One possibility for detecting quality-reducing events at the server consists in the transmitted data rate being detected by the server and the data rate received at the client being detected by the client and reported to the server. The server then establishes that a quality-reducing event has occurred if the difference between received and transmitted data rate exceeds a predetermined value. Another possibility for detecting the quality-reducing events at the server consists in data losses being detected by the client and reported to the server. The server then establishes that a quality-reducing event has occurred if the difference between received and transmitted data rate is below a predetermined value. Another possibility for detecting the quality-reducing events at the server consists in data losses being detected by the client and reported to the server, whereby the server detects the occurrence of a quality-reducing event as a function of the magnitude of the data losses. In a preferred variant the RTP/RTCP protocol is again used, and the received data rate detected by the client and/or the data losses detected by the client are communicated in the RTCP protocol. Known protocols can thus be used to implement the method according to the invention.

Another possibility for detecting quality-reducing events at the server is via the data buffer in the client, whereby the size of the buffer is known to the server or is communicated to the server when a transfer session is set up. In the event of data losses, the server is then informed by the client as to what data has been lost, the server calculating therefrom the occupancy level of the buffer and thereby determining the occurrence of quality-reducing events. The information as to what data has been lost in the event of data losses is preferably communicated to the server via an extension in the RTCP protocol.

The above-mentioned method is used particularly for data transfers which transmit data in the form of data packets as is the case, for example, with the IP protocol (IP=Internet Protocol).

In a further embodiment of the invention, the detection of the quality-reducing events at the server and the detection of the quality-reducing events at the client are combined so that the quality-reducing events are recorded both at the server and at the client, a comparison between the two quality-reducing events being performed whereby only the events which were detected both by the server and by the client are logged. A plausibility check is therefore inserted downstream in order to filter out any incorrectly detected quality-reducing events.

In addition to the above-described data transfer methods, the invention further relates to a data network with at least one first and at least one second computer, said data network being so designed that data is transferred between the first and the second computer in accordance with the transfer method according to the invention. This data network preferably comprises an IP network and/or a UMTS network and/or a WLAN network.

The invention additionally relates to a computer program product which has a storage medium on which a computer program is stored with which the data transfer method according to the invention is carried out when the computer program is run on a computer.

Exemplary embodiments of the invention will now be described below with reference to the accompanying drawings in which:

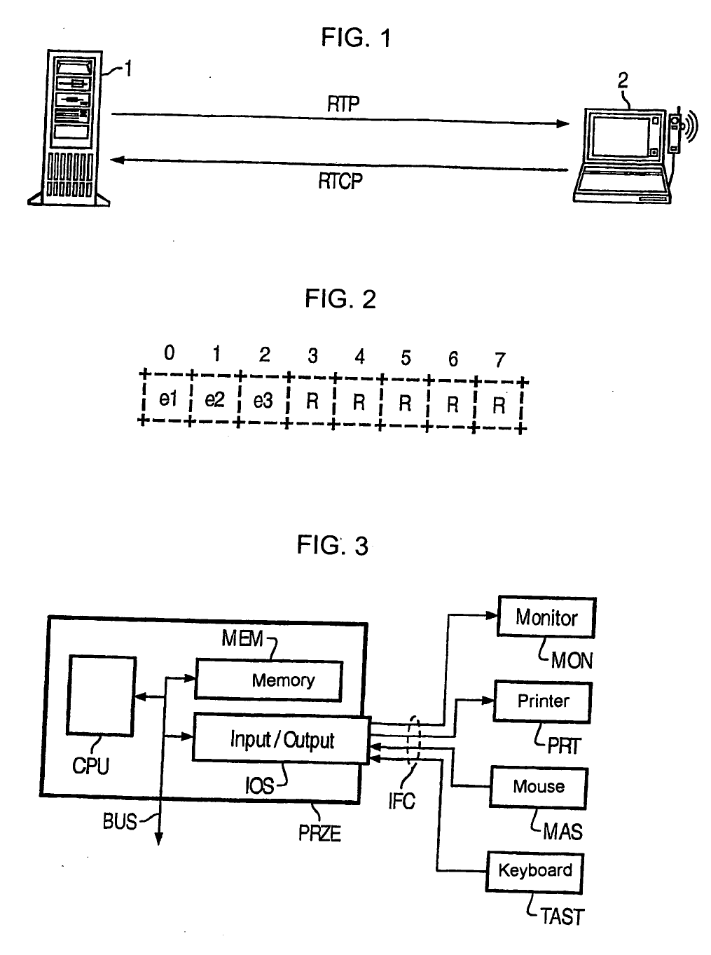

FIG. 1 schematically illustrates the transfer method according to the invention;

FIG. 2 schematically illustrates a feedback message which is used in one embodiment of the method according to the invention; and

FIG. 3 shows a processor unit for carrying out the method according to the invention.

The invention will now be described in connection with video streaming in which a video film consisting of a plurality of video images is downloaded from a server to a client where it is viewed by a user. For video streaming, three different categories of quality-reducing events were able be determined experimentally, said events being an annoyance to the viewer of the video film and therefore resulting in a reduction in the subjective quality of the multimedia data. The three events are:
1. Freezing of the image: with this event, the image remains static for a while.
2. Artifacts in the video image: with this event, parts of the video image look strange or blurred.
3. Quality reduction in the bit rate: with this event, the sharpness of the video image and the sharpness of the movements in the video image is reduced.

FIG. 1 shows a scenario in which the method according to the invention is used. FIG. 1 shows a server 1 and a client 2, the server providing video streaming data which is transmitted to the client using, inter alia, the IP protocol for data transfer. In the embodiment described here, the so-called RTP protocol which is sufficiently known from the prior art (see publication [1]) is additionally used. This protocol also includes the RTCP protocol with which so-called feedback messages for data transfer monitoring are sent back from the client to the server.

The method according to the invention enables the server to be informed about the three above-mentioned quality-reducing events and said events to be logged. In a first embodiment this is done by the client detecting the events and reporting them to the server. This requires that the client is able to detect the events. This is not usually a problem, as the client comprises, for displaying the video data, a player or decoder which recognizes the three above-mentioned quality-reducing events. To feed back the events, in the first embodiment the RTCP protocol is used which comprises a special extension byte which is schematically illustrated in FIG. 2.

FIG. 2 shows the extension byte with the bit positions 0 to 7. The first three bit positions 0 to 2 describe the corresponding quality-reducing events, e1 standing for the above-mentioned first event, e2 for the above-mentioned second event and e3 for the above-mentioned third event. When a quality-reducing event has been detected by the client, it sets the corresponding bit 0, 1 or 2 to the value 1. This provides information as to which quality-reducing event is present. The other bit fields denoted by R in FIG. 2 are intended for other quality-reducing events or can be used for additional quantification of these events. For example, these bits could be used to indicate how long the freezing of an image lasts or the number of artifacts occurring in the video image.

A disadvantage of this first embodiment of the method according to the invention is that the client may improperly report the occurrence of quality-reducing events to the server. For example, the client could be manipulated by the user so as to suggest to the server that poor image quality is present. This arises particularly if the occurrence of quality-reducing events triggers a corresponding reduction in the fee payable for the data transfer. This disadvantage can be overcome according to a second embodiment of the present invention. With this second embodiment, the server only infers that a quality-reducing event is present on the basis of the regular RTCP message which is not extended by the above described byte. This is possible, as the regular RTCP message already contains data transfer information with which the server can infer quality-reducing events. With this embodiment, the possibility of misuse by a user is greatly limited, as the quality of the-connection is adjusted down if the regular RTCP message reports continuously deteriorating quality. As a user has no interest in a deterioration in quality, any improper use by manipulation of the RTCP message is ruled out.

The individual quality-reducing events can be detected as follows at the server:

The “quality reduction in the bit rate” event is easy to detect on the server side, as the transmitted bit rate is known to the server. The client is informed of the transmitted bit rate by an RTCP message from the server. Thus, if the difference between transmitted and expected bit rate exceeds a predetermined value, a quality-reducing event is present

The “artifacts in the image” event is not so easily detected. This event is generally preceded by a data packet loss. Data packet losses can in turn be communicated to the server via the RTCP protocol. However, whether a packet loss produces a quality-reducing event due to artifacts in the image depends to a large extent on the client used. When analyzing a quality-reducing event, the server consequently has to know which client is present. This information can be made available to the server e.g. by determining a threshold value T for each client. This threshold value indicates that a quality-reducing event in the form of artifacts is present at the client if the packet loss is greater than T. The corresponding value T must be experimentally determined in advance. The quality-reducing event “artifacts in the image” is therefore detected whenever the data packet loss determined at the client exceeds a client-dependent threshold value T.

The quality-reducing event “freezing of the video image” generally occurs when the video image buffer in the client underruns, i.e. is virtually empty. To detect this event, the client informs the server when setting up the data connection as to the size of its buffer and how full the buffer has to be so that multimedia content can be displayed. During data transfer, the server is additionally informed via an extension in the RTCP as to which packets are lost and of the timestamp of the incoming packets. The server easily determines therefrom the buffer status. If the case now arises that the occupancy level of the buffer is below the value above which multimedia data is displayed, freezing of the video image occurs. If the server detects such a buffer underrun, it logs this as a quality-reducing event.

In a third embodiment of the method according to the invention, the first and the second embodiment are combined, i.e. the quality-reducing events are detected by both the client and the server. The server then compares the two detections. If no discrepancies occur, the detected events are logged as quality-reducing events. However, if, for example, a quality-reducing event is detected by the client which the server does not detect, this is highly likely to be a misuse, which means that the server does not log this event.

The above-described detection and logging of the quality-reducing events is used in a preferred embodiment of the invention for calculating the data transfer charges. This is to enable the price for data transfer also to be made dependent on the quality of the data. The multimedia data viewer therefore has to pay less, for example, if the quality is unsatisfactory, it depending on the provider as to how he charges the customer according to the quality-reducing events. For example, the provider may reimburse money to the customer if poor quality obtains over a lengthy period of time, the customer possibly being charged a reduced price for poor quality or having to pay nothing at all.

Although the above-described embodiments relate to the transfer of multimedia data in the form of video streaming, it will be obvious to the average person skilled in the art that the above invention can also be applied to the transmission of other data. Another field of application is e.g. telephony in an IP network, which is frequently termed voice over IP, whereby a mobile communications provider can factor voice quality into his billing.

The major advantage of the above-described linkage of quality-reducing events to billed prices is that a provider can supply a customer with a fair billing mode, thereby giving him an edge over other competitors.

FIG. 3 shows a processor unit PRZE for carrying out the method according to the invention. The processor unit PRZE comprises a processor CPU, a memory MEM and an input/output interface IOS which is used in different ways via an IFC interface: an output can be displayed on a monitor MON and/or output to a printer PRT via a graphical interface. An input is made via a mouse MAS or a keyboard TAST. The processor unit PRZE also has a data BUS which provides the connection from a memory MEM, the processor CPU and the input/output interface IOS. Additional components such as extra memory, data storage (hard disk) or scanner can also be connected to the data BUS.

### REFERENCES

[1] H. Schulzrinne, S. Casner, R. Frederick, and V. Jacob-son, “RTP: A transport protocol for real-time applications”, RFC 1889, IETF, February 1996.

1-18. (canceled)

19. A method for transferring data, the method which comprises:
transferring data between a server and a client;
detecting quality-reducing events that result in a deterioration in a quality of the transferred data;
detecting at least some of the quality-reducing events in the client and reporting the quality-reducing events in a feedback message from the client to the server;
detecting at least some of the quality-reducing events in the server; and
logging the quality-reducing events.

20. The method according to claim 19, which comprises transmitting digitized video images and detecting the following quality-reducing events:
freezing of video images;
artifacts in video images; and
reduction in a sharpness of video images.

21. The method according to claim 19, which comprises calculating fees to be charged to a user for data transfer as a function of the logged quality-reducing events.

22. The method according to claim 19, wherein the feedback message contains quantifying information for categorizing and/or specifying a particular quality-reducing event.

23. The method according to claim 19, which comprises communicatng in RTP/RTCP protocol and transmitting the feedback message in RTCP protocol.

24. The method according to claim 19, wherein the feedback message contains one or more bits.

25. The method according to claim 24, wherein the feedback message contains one byte.

26. The method according to claim 19, which comprises detecting a transmitted data rate with the server and detecting a received data rate with the client, and reporting the received data rate to the server, and wherein the server detects a quality-reducing event if the difference between the received data rate and the transmitted data rate exceeds a predetermined value.

27. The method according to claim 26, which comprises communicating in RTP/RTCP protocol and communicating the received data rate detected by the client in the RTCP protocol.

28. The method according to claim 19, which comprises reporting to the server data losses detected by the client, and determining with the server an occurrence of a quality-reducing event in dependence of a size of the data losses.

29. The method according to claim 28, which comprises communicating in RTP/RTCP protocol and communicating the data losses detected by the client in the RTCP protocol.

30. The method according to claim 28, wherein the client has a buffer with a buffer size known to the server, the server is informed by the client in the event of data losses what data have been lost, and the server calculates therefrom an occupancy level of the buffer and thereby determines the occurrence of quality-reducing events.

31. The method according to claim 30, which comprises communicating in RTP/RTCP protocol and communicating to the server the information what data has been lost via an extension in the RTCP protocol.

32. The method according to claim 19, which comprises comparing the quality-reducing events in the server and in the client, and logging only the quality-reducing events detected by the server and by the client.

33. The method according to claim 19, which comprises transmitting the data in data packets.

34. The method according to claim 33, which comprises transmitting Internet Protocol (IP) data packets.

35. A data network, comprising: at least one first and at least one second computer, the data network being configured to transfer data between the first and second computers with the method according to claim 19.

36. The data network according to claim 30, configured as an IP network and/or a UMTS network and/or a WLAN network.

37. A computer program product including storage media having stored thereon a computer program for carrying out the method of claim 19 when the computer program is run on a computer.

38. A computer-readable medium having stored thereon computer-executable instructions for performing the method according to claim 19.
